(19) United States
(12) Patent Application Publication
(10) Pub. No.: US 2025/0256247 A1
(43) Pub. Date: Aug. 14, 2025

(54) COMPOSITE SEMIPERMEABLE MEMBRANE AND METHOD FOR PRODUCING COMPOSITE SEMIPERMEABLE MEMBRANE

(71) Applicant: TORAY INDUSTRIES, INC., Tokyo (JP)

(72) Inventors: Masami OGATA, Shiga (JP); Kiyohiko TAKAYA, Shiga (JP); Naoki YAMAMOTO, Shiga (JP); Yoshiki NISHIGUCHI, Shiga (JP)

(73) Assignee: TORAY INDUSTRIES, INC., Tokyo (JP)

(21) Appl. No.: 18/833,105

(22) PCT Filed: Jan. 26, 2023
(86) PCT No.: PCT/JP2023/002534

§ 371 Date: Feb. 10, 2025

(30) Foreign Application Priority Data
Jan. 26, 2022 (JP) 2022-009924

(51) Int. Cl. B01D 69/12; B01D 61/02; B01D 67/00; B01D 69/02; B01D 71/56; C02F 1/44; C02F 101/10; C02F 101/34

(52) U.S. Cl. CPC B01D 69/1213; B01D 61/025; B01D 67/0016; B01D 69/02; B01D 71/56; C02F 1/441; B01D 2325/023; B01D 2325/06; B01D 2325/20; C02F 2101/10; C02F 2101/34

(57) ABSTRACT

The present invention relates to a composite semipermeable membrane including a porous layer and a separation functional layer provided on the porous layer, in which at least one of a surface layer elastic modulus (EA) and a surface layer elastic modulus (EB) is 0.6 GPa or more and 1.0 GPa or less, provided that the surface layer elastic modulus (EA) is obtained by measuring a surface of the porous layer pressurized under a condition A (7 MPa, 35° C., 6 hours) with an atomic force microscope (AFM) and the surface layer elastic modulus (EB) is obtained by measuring the surface of the porous layer pressurized under a condition B (7 MPa, 45° C., 24 hours) with the atomic force microscope (AFM).

### TECHNICAL FIELD

The present invention relates to a semipermeable membrane useful during a high-temperature and high-pressure operation, and relates to a composite semipermeable membrane excellent in an initial volume of water production and excellent in water permeability and removal rate even after the high-pressure operation, and relates to a method for producing the same.

### BACKGROUND ART

A composite semipermeable membrane having a substrate, a support layer, and a separation functional layer is used for a reverse osmosis treatment for removing a solute from raw water, such as seawater desalination. In the reverse osmosis treatment, a pressure equal to or greater than a difference between an osmotic pressure on a supply water side and an osmotic pressure on a permeate water side is applied to the supply water side of the composite semipermeable membrane.

It is pointed out in Patent Literatures 1 to 3 that during an operation of a seawater desalination device, water permeability of a composite semipermeable membrane may decrease, and as a cause thereof, a support layer is crushed to block pores therein.

Patent Literature 1 discloses the composite semipermeable membrane in which in an average membrane thickness t₀ (μm) and a pure water permeability coefficient p₀ (g/(cm²·S·MPa)) of the support layer after a pressure of 5.5 MPa is applied for 3 hours and the pressure is released, and an average membrane thickness t₁ (μm) and a pure water permeability coefficient p₁ (g/(cm²·S·MPa)) of the support layer after a pressure of 10 MPa is applied for 3 hours in a membrane thickness direction and the pressure is released, t₁/t₀ and p₁/p₀ satisfy specific numerical ranges. According to Patent Literature 1, t₁/t₀ and p₁/p₀ are indices representing an ability to resist densification of the support layer, that is, indices representing strength of a skeleton portion of a support membrane, and the densification of the membrane satisfying the above conditions is prevented.

The composite semipermeable membrane of Patent Literature 2 includes a dense layer in which the support layer is in contact with a separation functional layer, and a macrovoid layer located between the dense layer and a substrate. In particular, Patent Literature 2 discloses that when the number of macrovoids per unit length in a membrane surface direction in the macrovoid layer is within a specific range, a thickness of the support layer is maintained even during an operation under a high pressure.

Patent Literature 3 discloses that the composite semipermeable membrane is densified in advance for 2 hours or more in order to reduce a change in performance during an operation.

### CITATION LIST

### Patent Literature

Patent Literature 1: JP2001-252538A
Patent Literature 2: JP2018-039003A
Patent Literature 3: JP2014-014739A

### SUMMARY OF INVENTION

### Technical Problem

In a case of using natural supply water, such as seawater desalination, a temperature of the supply water is not constant throughout a year, the temperature increases in summer, and not only a pressure but also a high temperature causes a decrease in an increased volume of water.

An object of the present invention is to provide a composite semipermeable membrane which has a high initial volume of water production and can further maintain a volume of water production even in an operation under a high pressure and a high temperature, and to provide a method for producing the same.

### Solution to Problem

In order to solve the above problem, the present invention includes any of the following configurations (1) to (9).

In the present specification, parts, percentage, ratio, and the like based on weight are synonymous with parts, percentage, ratio, and the like based on mass.
(1) A composite semipermeable membrane including a porous layer and a separation functional layer provided on the porous layer, in which
at least one of a surface layer elastic modulus (EA) and a surface layer elastic modulus (EB) is 0.6 GPa or more and 1.0 GPa or less, provided that the surface layer elastic modulus (EA) is obtained by measuring a surface of the porous layer pressurized under a condition A (7 MPa, 35° C., 6 hours) with an atomic force microscope (AFM) and the surface layer elastic modulus (EB) is obtained by measuring the surface of the porous layer pressurized under a condition B (7 MPa, 45° C., 24 hours) with the atomic force microscope (AFM).
(2) The composite semipermeable membrane according to (1), in which the porous layer pressurized under the condition A or the condition B includes a dense layer having a porosity of 10% or less, and a thickness (d) of the dense layer is 300 nm or less.
(3) The composite semipermeable membrane according to (1) or (2), in which
at least one of a ratio (RaA/RaC) and a ratio (RaB/RaC) is 1.15 or less, provided that the ratio (RaA/RaC) is a ratio of a surface roughness (RaA) of the porous layer pressurized under the condition A to a surface roughness (RaC) of the porous layer pressurized under a condition C (5.5 MPa, 25° C., 2 hours) and the ratio (RaB/RaC) is a ratio of a surface roughness (RaB) of the porous layer pressurized under the condition B to the surface roughness (RaC) of the porous layer pressurized under the condition C.
(4) The composite semipermeable membrane according to any one of (1) to (3), further including a substrate, in which
the porous layer is provided on the substrate to form a composite of the substrate and the porous layer, and
a pure water permeability coefficient of at least one of the composite pressurized under the condition A and the composite pressurized under the condition B is 0.12×10⁻⁹ m³/(m²·sec·Pa) or more.
(5) The composite semipermeable membrane according to any one of (1) to (4), in which
an area ratio of a pore in a membrane thickness direction to an entire pore area in a range from the surface of the porous layer to a depth of 1.5 μm is 45% or more.
(6) The composite semipermeable membrane according to any one of (1) to (5), in which
a boron removal rate (%) of 80% or more with respect to a raw water supplied at an operation pressure of 5.5 MPa and having a pH of 6.5, a temperature of 25° C., a boron concentration of 5 ppm, and a NaCl concentration of 3.2 wt % is exhibited.
(7) The composite semipermeable membrane according to any one of (1) to (6), in which
a glucose removal rate is 90% or more and a value of (glucose removal rate—isopropyl alcohol removal rate) is 30% or more with respect to a 1000 ppm glucose aqueous solution having a temperature of 25° C. and a pH of 6.5 and a 1000 ppm isopropyl alcohol aqueous solution having a temperature of 25° C. and a pH of 6.5 which are supplied under conditions of an operation pressure of 0.75 MPa and a concentrated water flow rate of 3.5 L/min.
(8) A method for producing a composite semipermeable membrane, the method including:
a step (a) of forming a resin solution in which a thermoplastic resin is dissolved in a good solvent into a flat membrane shape;
a step (b) of coagulating the thermoplastic resin in a coagulation liquid containing a non-solvent and a good solvent of the thermoplastic resin to obtain a porous layer; and
a step (c) of forming a separation functional layer on the porous layer, in which
the step (b) includes forming a flow of the coagulation liquid in a thickness direction in the resin solution within 3 seconds after being immersed in the coagulation liquid.
(9) The method for producing a composite semipermeable membrane according to (8), in which
the resin solution is applied to a surface of a substrate, and
the coagulation liquid is pushed into the substrate from a back surface of the substrate to form the flow.

### Advantageous Effects of Invention

According to the present invention, it is possible to obtain a composite semipermeable membrane which is excellent in an initial volume of water production and exhibits excellent water production performance and an excellent desalination rate even when an operation is performed under standard conditions after a high-temperature and high-pressure operation.

### BRIEF DESCRIPTION OF DRAWINGS

FIG. 1 is a schematic cross-sectional view of a composite semipermeable membrane according to an embodiment of the present invention.

FIG. 2 is a schematic cross-sectional view of a porous layer.

FIG. 3 is a schematic cross-sectional view showing pores in a membrane thickness direction in the porous layer.

FIGS. 4A and 4B are images of cross sections of porous layers of Example 3 and Comparative Example 2 respectively, in which a pore shape is approximated to an ellipse.

### DESCRIPTION OF EMBODIMENTS

### [1. Composite Semipermeable Membrane]

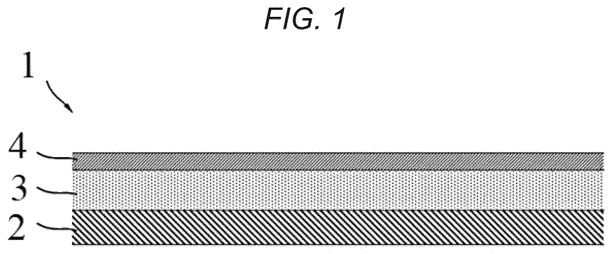

As an embodiment of the present invention, a composite semipermeable membrane 1 including a substrate 2, a porous layer 3 provided on the substrate 2, and a separation functional layer 4 provided on the porous layer as shown in FIG. 1 will be described below. However, the composite semipermeable membrane includes the porous layer and the separation functional layer provided on the porous layer, and the substrate is not an essential component.

### (1-1) Substrate

The substrate imparts strength to the composite semipermeable membrane and has sufficient water permeability. For a structure and a composition of the substrate, a technique known as a composite semipermeable membrane can be applied. Specifically, examples of the substrate include fabrics including polymers such as polyester, polyamide, polyolefin, and mixtures or copolymers thereof. The substrate is preferably nonwoven fabric.

A thickness of the substrate is preferably within a range of 10 μm to 200 μm, and more preferably within a range of 30 μm to 150 μm.

A pure water permeability coefficient of the substrate at 25° C. is preferably 200 [10⁻⁹ m³/m²/s/Pa] to 700 [10⁻⁹ m³/m²/s/Pa]. When the pure water permeability coefficient is in this range, a “flow” described later is easily formed in the resin solution at the time of forming the porous layer.

### (1-2) Porous Layer

The porous layer is preferably formed of a thermoplastic resin. Here, the thermoplastic resin refers to a resin which is made of linear polymeric substances and which, upon heating, shows a property of deforming or flowing by the action of external force.

Examples of the thermoplastic resin include homopolymers or copolymers of polysulfones, polyethersulfones, polyamides, polyesters, cellulose-based polymers, vinyl polymers, polyphenylene sulfates, polyphenylene sulfide sulfones, polyphenylene sulfones, and polyphenylene oxides, and these polymers can be used alone or as a blend thereof. Here, usable examples of the cellulose-based polymer include cellulose acetate and cellulose nitrate, and usable examples of the vinyl polymer include polyethylene, polypropylene, polyvinyl chloride, chlorinated vinyl chloride, and polyacrylonitrile. Among them, polysulfone, polyacrylonitrile, polyamide, polyester, polyvinyl alcohol, polyphenylene sulfide sulfone, polyphenylene sulfone, polyphenylene sulfide, polyethersulfone, polyvinylidene difluoride, cellulose acetate, polyvinyl chloride, or chlorinated vinyl chloride is preferable.

More preferably, examples thereof include cellulose acetate, polyvinyl chloride, chlorinated vinyl chloride, polysulfone, polyphenylene sulfide sulfone, and polyphenylene sulfone, and among these materials, the polysulfone can be generally used because the polysulfone has high chemical, mechanical, and thermal stability and is easily molded. The porous layer preferably contains the compounds listed above as a main component.

The polysulfone has a mass average molecular weight (Mw) of preferably 10000 or more and 200000 or less, more preferably 15000 or more and 100000 or less when measured by gel permeation chromatography (GPC) using N-methylpyrrolidone as a solvent and polystyrene as a standard substance.

When Mw of the polysulfone is 10000 or more, preferred mechanical strength and heat resistance for a porous layer can be obtained. In addition, when Mw of the polysulfone is 200000 or less, viscosity of a solution is in an appropriate range, and good moldability can be realized.

A thickness of the porous layer is preferably 20 μm or more and 250 μm or less, and more preferably 20 μm or more and 100 μm or less or 30 μm or more and 50 μm or less.

When the composite semipermeable membrane has the substrate, a thickness of the composite (hereinafter, referred to as “porous support”) of the substrate and the porous layer is preferably 30 μm or more and 300 μm or less, and more preferably 100 μm or more and 220 μm or less.

Note that, in the present specification, the thickness means an average value unless otherwise specified. The average value here represents an arithmetic average value. That is, the thickness of the porous support is obtained by calculating an average value of thicknesses at 20 points measured at an interval of 2 cm in a direction (plane direction of the membrane) orthogonal to a thickness direction in cross-sectional observation.

<Pressurization under Condition A, B, or C>

Pressurization under a condition A is performed by allowing an aqueous solution having a NaCl concentration of 3.2 wt % to permeate through the composite semipermeable membrane at 35° C. and 7 MPa for 6 hours.

Pressurization under a condition B is performed by allowing an aqueous solution having a NaCl concentration of 5.0 wt % to permeate through the composite semipermeable membrane at 45° C. and 7 MPa for 24 hours.

Pressurization under a condition C is performed by allowing the aqueous solution having the NaCl concentration of 3.2 wt % to permeate through the composite semipermeable membrane at 25° C. and 5.5 MPa for 2 hours.

In a case where the separation functional layer is removed before the pressurization, a water impermeable film such as a PTFE film is stacked on a surface of the porous layer and a pressure may be applied to a water impermeable film side of the porous layer (which may be the porous support) by an aqueous solution under the same condition.

### <Surface Layer Elastic Moduli (EA and EB)>

At least one of a surface layer elastic modulus EA measured with an atomic force microscope (AFM) with respect to the surface of the porous layer (a surface on a separation functional layer side) pressurized under the condition A, and a surface layer elastic modulus EB measured with respect to the surface of the porous layer pressurized under the condition B is preferably 0.60 GPa or more and 1.0 GPa or less. In the composite semipermeable membrane including the porous layer having the surface layer elastic modulus in this range, a decrease in water production performance is prevented even during a high-temperature and/or high-pressure operation. At least one of the surface layer elastic moduli EA and EB is preferably 0.65 GPa or more and 1.0 GPa or less, and more preferably 0.70 GPa or more and 0.95 GPa or less. It is also preferable that both the surface layer elastic moduli EA and EB are 0.60 GPa or more and 1.0 GPa or less.

In the porous layer, a pore functions as a water permeation path. In a case of the porous membrane, it is known that compressive strength is proportional to an elastic modulus and is inversely proportional to a porosity. The lower the porosity is, the higher the compressive strength is, and thus collapse at the high-temperature and/or high-pressure operation is prevented. On the other hand, the higher the porosity is, the greater the number of water permeation paths within the porous layer is, and thus the water permeability is improved. In order to satisfy conflicting requirements of preventing the collapse and ensuring the water permeation path, the inventors focus on a surface layer structure of the porous layer, which has the largest influence on the water permeability, and conduct studies.

Regarding the surface layer elastic moduli EA and EB, the elastic moduli in a submicron region from a surface layer of the porous layer are measured, and when the surface layer elastic modulus EA or EB is in the above range, the collapse of the porous structure (blockage of the water passage) due to pressure is prevented, and thus the water permeation path is maintained. As a result, even when the operation is performed at a high temperature and/or a high pressure, a decrease in the water permeability of the porous layer and a decrease in a volume of water production of the composite semipermeable membrane can be prevented.

The surface layer elastic moduli EA and EB are values measured for the porous layer in which the separation functional layer is removed and the surface is exposed. The removal of the separation functional layer may be performed either before or after the pressurization under the condition A or the condition B. For example, after the separation functional layer is removed from the composite semipermeable membrane, the porous layer (which may be the porous support) may be pressurized under the condition A or the condition B, or the separation functional layer may be removed from the composite semipermeable membrane pressurized under the condition A or the condition B.

When the separation functional layer is composed of polyamide, examples of a method of removing the separation functional layer from the composite semipermeable membrane include a method of immersing the composite semipermeable membrane in an aqueous solution containing 2 wt % of sodium hypochlorite for 24 hours to 48 hours.

The surface layer elastic moduli EA and EB can be measured using the atomic force microscope (AFM). Specifically, the porous layer (which may be the porous support) is fixed to a slide glass, a cantilever of the atomic force microscope is pressed against the surface of the porous layer and then separated, and the elastic moduli are calculated from a deflection amount of the cantilever and a deformation amount of the cantilever read from an obtained force curve, and a spring coefficient of the cantilever obtained in advance. Details will be described later.

Specifically, by satisfying at least one of the following conditions, the porous layer can achieve the surface layer elastic modulus EA or EB in the above range. The porous layer preferably satisfies two or more conditions below.
(a) The porosity in a portion from the surface layer to a depth of 500 nm is 10% to 30%. 12% to 25% is more preferable.
(b) A portion from the surface to the depth of 500 nm is formed of a thermoplastic resin softer than a portion exceeding the depth of 500 nm. For example, the portion from the surface to the depth of 500 nm is polyvinyl chloride, and the portion exceeding the depth of 500 nm is polysulfone.
(c) A ratio of pores in a membrane thickness direction at a depth of 1.5 μm from the surface layer of the porous layer is 45% or more.

The condition (c) is preferable because it is possible to keep the elastic modulus within the above range since a pore path is less likely to be blocked even after being pressurized in the membrane thickness direction and surface layer voids can be maintained.

### <Dense Layer>

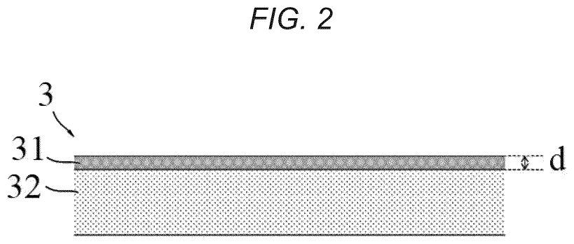

The porous layer 3 has an asymmetric structure. In the porous layer 3, a pore diameter in the surface on the separation functional layer side is small, and a pore diameter continuously or discontinuously increases toward the other surface along the thickness direction. A region including the surface on the separation functional layer side of the porous layer and having a resin ratio of 90% or more in a cross-sectional image is referred to as a dense layer 31, and a portion having a resin ratio of less than 90% is referred to as a coarse layer 32 (FIG. 2).

The dense layer is determined as follows. The frozen composite semipermeable membrane is cleaved, and the obtained cross section is observed. After the cleaved membrane is dried, platinum/palladium or ruthenium tetroxide, preferably ruthenium tetroxide is deposited on the membrane cross section to obtain an observation sample. The membrane cross section is imaged with an electrolytic emission electron microscope at magnification of 100,000 times to obtain an image. The image is converted into 8 bits by processing software, and binarization processing is performed to set a minimum value of a threshold to 0, a maximum value thereof to 115, a portion within the range to be black, and the rest to be white. A ratio of black to white is calculated every 20 nm from the surface layer, and a range in which an area of the black portion per the cross-sectional direction is 10% or less (that is, the porosity is 10% or less) is defined as the dense layer.

In the porous layer pressurized under the condition A or the condition B, a dense layer thickness d is preferably 300 nm or less, and more preferably 200 nm or less.

Since the dense layer 31 has a large resistance and has the dense layer thickness d of 300 nm or less, high water permeability can be obtained even under a high-pressure operation. As a result, it is possible to prevent a decrease in the volume of water production of the composite semipermeable membrane. A lower limit of the dense layer thickness d of the pressurized porous layer is not particularly limited, and is preferably 50 nm or more in view of the strength of the membrane.

Examples of a specific method for achieving the dense layer thickness of 300 nm or less after the pressurization include satisfying at least one, preferably two or more of.
(a) adding a fiber material to a thermoplastic resin or the like to increase the strength of the support layer,
(b) setting an area ratio of the pores in the membrane thickness direction to 45% or more, and
(c) setting an initial dense layer thickness t₀ 100 nm or less. In particular, (b) and (c) are preferably satisfied. The above (a) and (b) can prevent the collapse of the support layer. In addition, in the above (c), even when the support layer is collapsed by the pressurization and the thickness of the dense layer increases, the thickness of the dense layer after the pressurization can be reduced to 300 nm or less.
   <Ratio (RaA/RaC), (RaB/RaC) of Surface Roughness of Porous Layer Pressurized under Condition A, B, or C>

At least one of ratios (RaA/RaC) and (RaB/RaC) of surface roughness (RaA, RaB) of the porous layer pressurized under the condition A and the condition B to the surface roughness (RaC) of the porous layer pressurized under the condition C is preferably 1.0 or more and 1.15 or less. By setting at least one of (RaA/RaC) and (RaB/RaC) within this range, it is possible to decrease a change in unevenness of the surface layer of the support during the high-pressure operation, and it is possible to further reduce a change (drop) in unevenness of the separation functional layer formed on the porous layer. As a result, since a surface area of the separation functional layer can be maintained, a decrease in the volume of water production can be prevented, which is preferable. It is also preferable that both (RaA/RaC) and (RaB/RaC) are 1.0 or more and 1.15 or less.

In order to set the ratio (RaA/RaC) or the ratio (RaB/RaC) within the above range, for example, the area ratio of the pores in the membrane thickness direction may be 45% or more. When the area ratio of the pores in the membrane thickness direction is within this range, the entire membrane surface is uniformly compressed.

### <Surface Pore Diameter of Porous Layer>

A surface pore diameter of the porous layer preferably is 3 nm or more and 10 nm or less. Accordingly, a pore diameter of a surface in contact with the separation functional layer can be reduced, and the drop of the separation functional layer can be limited to be small.

<Pure Water Permeability Coefficient of Porous Layer Pressurized under Condition A or Condition B>

A pure water permeability coefficient of the porous layer (which may be the porous support) pressurized under the condition A or the condition B is preferably 0.12 (×10⁻⁹ m³/(m²·sec·Pa)) or more. The water permeability of the porous layer (which may be the porous support) after the pressurization is 0.12 or more, so that resistance of the porous layer in the composite semipermeable membrane becomes sufficiently small. As a result, it is possible to prevent a decrease in the volume of water production after the high-pressure operation in the composite semipermeable membrane during the high-pressure operation.

In order to set the pure water permeability coefficient of the porous layer (which may be the porous support) pressurized under the condition A or the condition B to 0.12 (×10⁻⁹ m³/(m²·sec·Pa)) or more, it is preferable that the surface layer of the porous layer has a high porosity (for example, 10% or more and 30% or less), the porous layer contains a resin having a hydrophilic functional group, or the area ratio of the pores in the membrane thickness direction is 45% or more.

The pure water permeability coefficient of the porous layer (which may be the porous support) pressurized under the condition A or the condition B is more preferably 0.15 (×10⁻⁹ m³/(m²·sec·Pa)) or more, and still more preferably 0.20 or more.

### <Area Ratio of Pores in Membrane Thickness Direction>

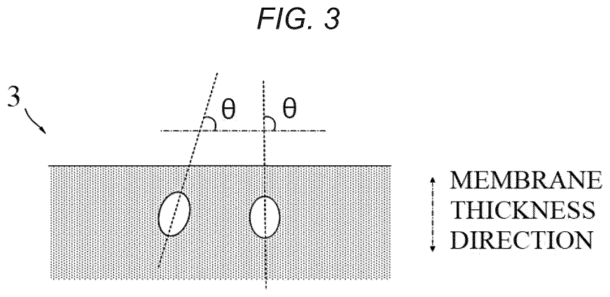

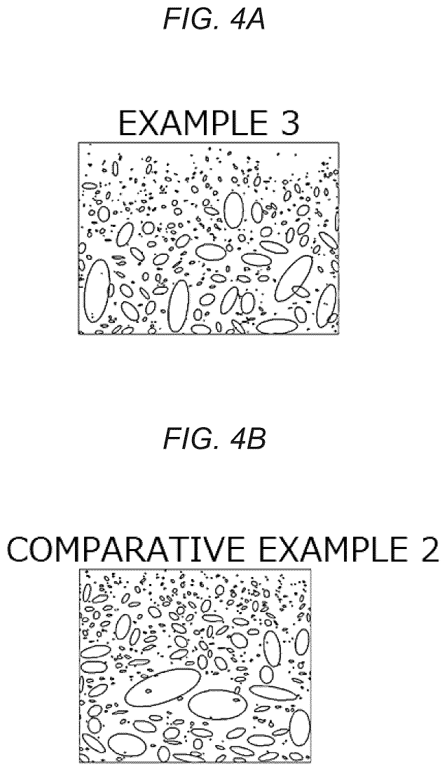

The membrane cross section in the same direction as in the case of detecting the dense layer is imaged by a scanning transmission electron microscope (STEM). In a range up to 1.5 μm from the surface of the porous layer of the obtained image, the pores are approximated to ellipses by image processing (FIGS. 4A and 4B). In some cases, a pore long in one direction is actually recognized as an ellipse, and in other cases, a plurality of small pores adjacent to each other may be connected and recognized as one ellipse. Among the ellipses detected in this manner, the pore in which an angle θ of a major axis is 45 degrees or more and 135 degrees or less with respect to a membrane surface direction is the pore in the membrane thickness direction (FIG. 3).

The area ratio of the pores in the membrane thickness direction is the ratio of the pores in the membrane thickness direction to a total area of all the ellipse-approximated pores.

It is preferable that the area ratio of the pores in the membrane thickness direction in the range up to 1.5 μm from the surface of the porous layer is 45% or more.

During water passage, water that has permeated the separation functional layer passes through the pores of the porous layer and exits to the substrate. That is, the pore functions as a water flow path. When the area ratio of the pores in the membrane surface direction is 45% or more, even if the pressure is applied in the membrane thickness direction and a part of the porous layer is collapsed, the water flow path in the membrane thickness direction is maintained, and thus it is possible to prevent a decrease in the water permeability after the pressurization.

A range of the area ratio of the pores in the membrane thickness direction is preferably 45% or more and 90% or less, and more preferably 65% or more and 80% or less.

### (1-3) Separation Functional Layer

The separation functional layer contains a crosslinked aromatic polyamide. In particular, the separation functional layer preferably contains a crosslinked aromatic polyamide as a main component. The main component refers to a component occupying 50 wt % or more of the components of the separation functional layer. When the separation functional layer contains 50 wt % or more of the crosslinked aromatic polyamide, higher removal performance can be exhibited. A content of the crosslinked aromatic polyamide in the separation functional layer is preferably 80 wt % or more, and more preferably 90 wt % or more.

The crosslinked aromatic polyamide can be formed by a chemical reaction of a polyfunctional aromatic amine and a polyfunctional aromatic acid chloride. Here, at least one of the polyfunctional aromatic amine and the polyfunctional aromatic acid chloride preferably contains a trifunctional or higher functional compound. Accordingly, a rigid molecular chain is obtained and a good pore structure is formed for removing hydrated ions and fine solutes such as boron.

The polyfunctional aromatic amine means an aromatic amine having two or more amino groups of at least one of a primary amino group and a secondary amino group in one molecule, and at least one of the amino groups is a primary amino group. Examples of the polyfunctional aromatic amine include polyfunctional aromatic amines in which two amino groups are bonded to an aromatic ring in any positional relationship of an ortho position, a meta position, and a para position, such as o-phenylenediamine, m-phenylenediamine, p-phenylenediamine, o-xylylenediamine, m-xylylenediamine, p-xylylenediamine, o-diaminopyridine, m-diaminopyridine, and p-diaminopyridine; and polyfunctional aromatic amines such as 1,3,5-triaminobenzene, 1,2,4-triaminobenzene, 3,5-diaminobenzoic acid, 3-aminobenzylamine, and 4-aminobenzylamine. Examples thereof also include aliphatic amines such as ethylenediamine and propylene diamine, and alicyclic polyfunctional amines such as 1,2-diaminocyclohexane, 1,4-diaminocyclohexane, piperazine, 2,5-dimethylpiperazine, 2-methylpiperazine, 2,6-dimethylpiperazine, 2,3,5-trimethylpiperazine, 2,5-diethylpiperazine, 2,3,5-triethylpiperazine, 2-n-propylpiperazine, 2,5-di-n-butylpiperazine, 1,3-bis-piperidylpropane, and 4-aminomethylpiperazine. These polyfunctional amines may be used alone or in combination.

In particular, in consideration of selective separability, permeability, and heat resistance of the membrane, m-phenylenediamine, p-phenylenediamine, and 1,3,5-triaminobenzene are preferably used. Among them, m-phenylenediamine (hereinafter also referred to as m-PDA) is more preferably used in view of availability and ease of handling. These polyfunctional aromatic amines may be used alone or in combination of two or more thereof.

The polyfunctional aromatic acid chloride refers to aromatic acid chloride having at least two chlorocarbonyl groups in one molecule. Examples of the trifunctional acid chloride may include trimesoyl chloride, and examples of a bifunctional acid chloride may include biphenyl dicarboxylic acid dichloride, azo benzene dicarboxylic acid dichloride, terephthalic acid chloride, isophthalic acid chloride, and naphthalene dicarboxylic acid chloride. Examples include an aliphatic bifunctional acid halide such as adipoyl chloride and sebacoyl chloride, and an alicyclic bifunctional acid halide such as cyclopentanedicarboxylic acid dichloride, cyclohexanedicarboxylic acid dichloride, and tetrahydrofurandicarboxylic acid dichloride. These polyfunctional acid halides may be used alone or in combination.

In consideration of the selective separability and heat resistance of the membrane, the polyfunctional aromatic acid chloride having 2 to 4 chlorocarbonyl groups in one molecule is preferable.

### [2. Method for Producing Composite Semipermeable Membrane]

A method for producing a composite semipermeable membrane according to the present invention includes: a step (a) of forming a resin solution in which a thermoplastic resin is dissolved in a good solvent into a flat membrane shape; a step (b) of coagulating the thermoplastic resin in a coagulation liquid containing a non-solvent and the good solvent of the thermoplastic resin to obtain a porous layer; and a step (c) of forming a separation functional layer on the porous layer, and the step (b) includes a step of forming a flow of the coagulation liquid in a thickness direction in the resin solution within 3 seconds after being immersed in the coagulation liquid.

### (2-1) Step of Forming Porous Layer

A step of forming the porous layer includes:
the step (a) of forming the resin solution in which a thermoplastic resin (hereinafter, referred to as the resin) is dissolved in a good solvent into the flat membrane shape; and
the step (b) of obtaining the porous layer by coagulating the resin in a coagulation liquid containing a non-solvent and the good solvent of the resin.

The step of forming the porous layer may further include a step of dissolving the resin, which is a component of the porous layer, in the good solvent for the resin to prepare a resin solution.

The term “resin” is a material serving as a main component of the porous layer, and is specifically as described above. The following conditions are particularly preferably applied when the resin is polysulfone.

The “good solvent” dissolves the resin. By selecting the good solvent, a rate of the good solvent flowing out from the resin solution in the step (b) can be adjusted. As a result, the surface layer elastic modulus, the dense layer thickness, and the surface roughness of the porous layer can be controlled. As the good solvent, for example, at least one kind of solvent selected from the group consisting of amides such as N-methyl-2-pyrrolidone (NMP), tetrahydrofuran (THF), dimethyl sulfoxide (DMSO), tetramethylurea (THU), N,N-dimethylacetamide (DMAc)-N,N-dimethylformamide (DMF), N,N-dimethylisobutyramide (DMIB), N,N-diisopropylisobutyramide, and N,N-bis(2-ethylhexyl)isobutyramide; lower alkyl ketones such as acetone and methyl ethyl ketone (MEK); esters such as trimethyl phosphate; and lactones such as γ-butyrolactone is preferably used. More preferably, dimethyl sulfoxide (DMSO) and N,N-dimethylformamide (DMF) are used as the good solvent.

The step (a) can be performed by applying the resin solution onto a board or the substrate described above, or immersing the substrate in the resin solution. When the board is used, the porous layer is peeled off from the board after the step (b).

The application of the resin solution onto the board or the substrate can be performed by various coating methods, and a pre-measuring coating method capable of applying the solution in an accurate amount, such as die coating, slide coating, or curtain coating is preferably applied. Furthermore, for forming the porous layer, it is more preferred to use a slit die method for applying the resin solution.

A resin concentration concentration (that is, a solid content concentration) in the resin solution is preferably 15 wt % or more, more preferably 16 wt % or more, and still more preferably 17 wt % or more. The resin concentration is also preferably 30 wt % or less, more preferably 25 wt % or less, and still more preferably 20 wt % or less.

When the resin concentration is 15 wt % or more and the area ratio of the pores in the membrane thickness direction in the range from the surface layer of the porous layer to the depth of 1.5 μm is 45% or more, the value of the surface layer elastic modulus can be 0.6 GPa or more. The area ratio of the pores in the membrane thickness direction can be adjusted by setting the resin concentration within the above range and forming the flow of the coagulation liquid as described later. When the area ratio of the pores in the membrane thickness direction is in the same range and the resin concentration is 17 wt % or more, the surface layer elastic modulus can be 0.7 GPa or more.

When the resin concentration is 30 wt % or less, the viscosity of the resin solution falls within an appropriate range, and a structure in which pores of the dense layer are connected can be obtained. Accordingly, within this range, it is possible to obtain a good initial volume of water production and a good volume of water production after the pressurization of the composite semipermeable membrane.

A temperature of the resin solution when applied to the substrate is preferably within a range of 10° C. to 60° C. Within this range, the resin solution is sufficiently impregnated between the fibers of the substrate without the resin solution being precipitated, and then solidified. As a result, the porous layer is firmly bonded to the substrate by impregnation, and the porous layer can be obtained. The preferred temperature range of the resin solution may be appropriately adjusted according to the viscosity of the used resin solution.

The solvent contained in the resin solution may be the same solvent or different solvents as long as the solvent is a good solvent for the resin. It can be appropriately adjusted in consideration of strength characteristics of the porous layer to be produced and the impregnation of the resin solution into the substrate.

The above resin solution may contain additives for adjusting the dense layer, a void layer, the pore diameter, porosity, hydrophilicity, the elastic modulus, and the like of the porous layer. Examples of the additive for adjusting the pore diameter and the porosity include, but are not limited to, water, alcohols, water-soluble polymers such as polyethylene glycol, polyvinylpyrrolidone, polyvinyl alcohol, and polyacrylic acid, or salts thereof, inorganic salts such as lithium chloride, sodium chloride, calcium chloride, and lithium nitrate, formaldehyde, and formamide. Examples of the additive for adjusting the hydrophilicity and the elastic modulus include various surfactants.

By applying the resin solution to the substrate, the resin solution is impregnated into the substrate as described above. In order to control the impregnation of the resin solution into the substrate, for example, a method of controlling a time until the substrate is immersed in the coagulation liquid (coagulation bath) after the resin solution is applied on the substrate, or a method of controlling the temperature or the concentration of the resin solution to further adjust the viscosity may be exemplified, and these methods may be combined.

In the step (b), a three-dimensional network structure can be formed by immersing the resin solution provided on the substrate in a coagulation liquid having a smaller resin solubility than that of the good solvent in the resin solution and coagulating the resin.

In addition, when the coagulation liquid contains a non-solvent such as water and a good solvent, the dense layer can be formed on the surface of the membrane by non-solvent-induced phase separation.

A concentration of the good solvent in the coagulation liquid is preferably 0.5 wt % or more, 5 wt % or more, or 10 wt % or more, and 50 wt % or less, or 30 wt % or less. A type of the good solvent is as described above.

A concentration of the non-solvent in the coagulation liquid is preferably 50 wt % or more or 70 wt % or more, and preferably 95 wt % or less or 90 wt % or less.

Examples of the non-solvent include water, aliphatic hydrocarbons such as hexane, pentane, benzene, toluene, methanol, ethanol, trichlorethylene, ethylene glycol, diethylene glycol, triethylene glycol, propylene glycol, butylene glycol, pentanediol, hexanediol, and low molecular weight polyethylene glycol, aromatic hydrocarbons, aliphatic alcohols, and mixed solvents thereof.

The step (b) includes forming a flow of the coagulation liquid in the thickness direction in the resin solution at an initial phase separation stage. The initial phase separation stage is a period after the resin solution is immersed in the coagulation liquid and before the coagulation is completed, and is, for example, within 3 seconds, preferably within 2 seconds, and further preferably within 1 second after being immersed in the coagulation liquid. By forming the flow of the coagulation liquid before the coagulation, the area ratio of the pores in the membrane thickness direction can be improved. Specifically, examples of a method for “forming a flow” include pushing the coagulation liquid from a substrate side toward the resin solution (that is, from a back surface of the substrate) or suctioning the coagulation liquid from the substrate side (from the back surface of the substrate).

The pressure of the pushing or suctioning for forming the flow is preferably 1 kPa to 3 kPa.

A pushing or suctioning time is preferably 3 seconds to 10 seconds.

A liquid temperature of the coagulation liquid is preferably within a range of 5° C. to 50° C., and more preferably within a range of 5° C. to 30° C. When the temperature is 50° C. or lower, vibration of a surface of the coagulation liquid due to thermal motion is not intensified, and smoothness of the surface of the porous layer is increased. When the temperature is 5° C. or more, a sufficient coagulation rate is obtained, and a membrane forming property is good. When the temperature of the coagulation liquid is in the above range, the surface pore diameter can be 3 nm or more and 10 nm or less.

Next, the obtained porous support is preferably subjected to hot water washing to remove the membrane forming solvent remaining in the membrane. A temperature of the hot water in this case is preferably 50° C. to 100° C., further preferably 60° C. to 95° C. By washing at 100° C. or lower, a shrinkage degree of the porous support can be kept small. By washing at 50° C. or higher, a high washing effect can be obtained.

### (2-2) Step of Forming Separation Functional Layer

Next, the step (c) of forming the separation functional layer will be described.

The separation functional layer is obtained by forming a crosslinked aromatic polyamide by a chemical reaction of a polyfunctional aromatic amine and a polyfunctional aromatic acid chloride. As a method for the chemical reaction, an interfacial polymerization method is most preferable from a viewpoint of productivity and performance. That is, the separation functional layer is formed by using an aqueous solution containing a polyfunctional amine and an organic solvent containing polyfunctional acid halide and performing interfacial polycondensation on the surface of the porous layer. By this step, a crosslinked polyamide is formed.

More specifically, the step of interfacial polymerization includes a step (i) of bringing an aqueous solution containing a polyfunctional aromatic amine into contact with the porous layer, and a step (ii) of bringing a solution in which polyfunctional aromatic acid chloride is dissolved into contact with the porous layer after the step (i).

In the step (i), a concentration of the polyfunctional aromatic amine in the polyfunctional aromatic amine aqueous solution is preferably in a range of 0.1 wt % or more and 20 wt % or less, and more preferably in the range of 0.5 wt % or more and 15 wt % or less. When the concentration of the polyfunctional aromatic amine falls within this range, sufficient solute removability and water permeability can be obtained.

The polyfunctional aromatic amine aqueous solution is preferably brought into contact with the porous layer uniformly and continuously. Specifically, examples thereof include a method of coating a porous layer with a polyfunctional aromatic amine aqueous solution, and a method of immersing a porous layer in a polyfunctional aromatic amine aqueous solution. The contact time between the porous layer and the polyfunctional aromatic amine aqueous solution is preferably 1 second or longer and 10 minutes or shorter, and more preferably 10 seconds or longer and 3 minutes or shorter.

After the polyfunctional aromatic amine aqueous solution is brought into contact with the porous layer, the solution is removed such that liquid droplets do not remain on the membrane. The liquid removal can prevent occurrence of a defect in the separation functional layer. As the liquid removal method, a method of holding the support membrane after being in contact with the polyfunctional aromatic amine aqueous solution in a vertical direction and allowing the excess aqueous solution to naturally flow down, a method of forcibly removing the liquids by blowing an air flow such as nitrogen from an air nozzle, or the like can be used. In addition, after the liquid removal, the membrane surface may be dried to partially remove water of the aqueous solution.

In the step (ii), a concentration of the polyfunctional aromatic acid chloride in the organic solvent solution is preferably in the range of 0.01 wt % to 10 wt %, and more preferably in the range of 0.02 wt % to 2.0 wt %. The reason is that a sufficient reaction rate can be obtained when the concentration is 0.01 wt % or more, and occurrence of a side reaction can be prevented when the concentration is 10 wt % or less.

The organic solvent is preferably one that is immiscible with water, dissolves the polyfunctional aromatic acid chloride, and does not break the support membrane, and any solvent may be used as long as the solvent is inert to the polyfunctional aromatic amine and the polyfunctional aromatic acid chloride. Preferable examples thereof include hydrocarbon compounds such as n-nonane, n-decane, n-undecane, n-dodecane, isooctane, isodecane, and isododecane, and a mixed solvent thereof.

The method for bringing the organic solvent solution of the polyfunctional aromatic acid chloride into contact with the porous layer brought into contact with the polyfunctional aromatic amine aqueous solution may be the same as the method for coating the porous layer with the polyfunctional aromatic amine aqueous solution.

After the reaction, the organic solvent is removed from the surface of the membrane. The removal of the organic solvent can use, for example, a method of holding the membrane in a vertical direction to remove an excess organic solvent by allowing the excess organic solvent to naturally flow down, a method of drying and removing an organic solvent by blowing air with a blower, or a method of removing an excess organic solvent with a mixed fluid of water and air.

In addition, depending on performance of a target composite semipermeable membrane, a crosslinked aliphatic polyamide or a crosslinked alicyclic polyamide may be formed by using an aliphatic amine or a alicyclic polyfunctional amine instead of the polyfunctional aromatic amine and using an aliphatic bifunctional acid halide or a alicyclic bifunctional acid halide instead of the polyfunctional aromatic acid chloride.

### [3] Method for Using Composite Semipermeable Membrane

The composite semipermeable membrane is wound around a tubular water collection pipe in which a large number of holes are bored together with a supply water channel material such as a plastic net, a permeated water channel material such as a tricot, and a film for increasing pressure resistance as necessary, to be suitably used as a spiral type composite semipermeable membrane element. Further, the composite semipermeable membrane can also be used as a composite semipermeable membrane module in which such elements are connected in series or in parallel and accommodated in a pressure vessel.

The composite semipermeable membrane, and the element and the module thereof described above can be combined with a pump that supplies supply water thereto, a device that pretreats the supply water, and the like to constitute a fluid separation device. By using this separation device, the supply water can be separated into the permeated water, such as drinking water, and concentrated water, which does not permeate the membrane, to obtain intended water.

Examples of the supply water include a liquid mixture containing 500 mg/L or more and 100 g/L or less of total dissolved solids (TDS) such as seawater, brackish water, and wastewater. In general, TDS refers to an amount of total dissolved solids and is represented by “mass÷volume” or a “weight ratio”. According to the definition, the TDS can be calculated based on a weight of a residue obtained by evaporating, at a temperature of 39.5° C. or higher and 40.5° C. or lower, a solution filtrated through a 0.45 μm filter, but is more conveniently converted from practical salinity (S).

In consideration that, as the operation pressure of the fluid separation device increases, a solute removal rate increases but energy required for the operation also increases, and in consideration of durability of the composite semipermeable membrane, the operation pressure when water to be treated permeates the composite semipermeable membrane is preferably 0.5 MPa or more and 12 MPa or less. The temperature of the supply water is preferably 5° C. or higher and 45° C. or lower since the solute removal rate decreases as the temperature increases and a membrane permeation flux decreases as the temperature decreases.

In the case of the supply water having a high solute concentration such as seawater, when the pH of the supply water is increased, there is a concern that scale of magnesium or the like is generated, and there is a concern that the membrane is deteriorated by a high pH operation, and thus an operation in a neutral region is preferred.

### [4] Performance of Composite Semipermeable Membrane as Reverse Osmosis Membrane

### (4-1) Desalination Rate (NaCl Removal Rate) and Boron Removal Rate

The composite semipermeable membrane according to the present invention preferably exhibits a boron removal rate (%) of 80% or more with respect to raw water supplied at an operation pressure of 5.5 MPa and having a pH of 6.5, a temperature of 25° C., a boron concentration of 5 ppm, and a NaCl concentration of 3.2 wt %, as a performance suitable for seawater desalination.

The boron removal rate can be obtained as follows.

First, the raw water (NaCl concentration: 3.2 wt %, boron concentration: 5 ppm) adjusted to a temperature of 25° C. and a pH of 6.5 is supplied to the composite semipermeable membrane at the operation pressure of 5.5 MPa to perform a membrane filtration treatment for 2 hours, and thereafter, electrical conductivities of the supply water and the permeated water are measured by a multi water quality meter (MM60R) manufactured by DKK-TOA Corporation. Next, by using a calibration curve created in advance, the conductivity is converted to calculate the NaCl concentration. From this NaCl concentration, the salt removal performance, that is, the NaCl removal rate is obtained by the following equation.

$$NaCl removal rate ( \% ) = 100 \times \{ 1 - ( NaCl concentration in permeated water / NaCl concentration in supply water ) \}$$

Subsequently, the boron removal rate is calculated based on the following equation.

$$Boron removal rate ( \% ) = 100 \times \{ 1 - ( boron concentration in permeated water / boron concentration in supply water ) \}$$

The boron concentrations in the raw water and the permeated water may be measured by using an ICP emission spectrometer (5110 ICP-OES, manufactured by Agilent Technologies) after collecting a sample liquid at the time of measuring desalting performance.

### (4-2) Glucose Removal Rate and Isopropyl Alcohol Removal Rate

### (4-2-1) Isopropyl Alcohol Removal Rate

An isopropyl alcohol removal rate of the composite semipermeable membrane is obtained as follows.

An evaluation is made by comparing isopropyl alcohol concentrations of the permeated water and the supply water when a 1000 ppm isopropyl alcohol aqueous solution adjusted to a temperature of 25° C. and a pH of 6.5 is supplied to the composite semipermeable membrane at an operation pressure of 0.75 MPa and a concentrated water flow rate of 3.5 L/min. That is, the isopropyl alcohol removal rate is calculated by isopropyl alcohol removal rate (%)=100×(1−(isopropyl alcohol concentration in permeated water/isopropyl alcohol concentration in supply water)). The isopropyl alcohol concentration is obtained by using a gas chromatograph (GC-18A manufactured by Shimadzu Corporation).

In a membrane for separating an alkali metal salt, the isopropyl alcohol removal rate in the composite semipermeable membrane is preferably 70% or less, and more preferably 65% or less. A lower limit value of the isopropyl alcohol removal rate is not particularly limited, and is, for example, 5%.

### (4-2-2) Glucose Removal Rate

A glucose removal rate of the composite semipermeable membrane is obtained as follows.

An evaluation is made by comparing glucose concentrations of the permeated water and the supply water when a 1000 ppm glucose aqueous solution adjusted to a temperature of 25° C. and a pH of 6.5 is supplied to the composite semipermeable membrane at an operation pressure of 0.75 MPa and a concentrated water flow rate of 3.5 L/min. That is, the glucose removal rate is calculated by glucose removal rate (%)=100×(1−(glucose concentration in permeated water/glucose concentration in supply water)). The glucose concentration is obtained by a refractometer (RID-6A manufactured by Shimadzu Corporation).

In the present invention, from a viewpoint of the separation application of the alkali metal salt, the glucose removal rate of the composite semipermeable membrane is preferably 90% or more. An upper limit value of the glucose removal rate is not particularly limited, and is, for example, 99.9%.

### (4-2-3) (Glucose Removal Rate—Isopropyl Alcohol Removal Rate)

In the composite semipermeable membrane of the present invention, (glucose removal rate—isopropyl alcohol removal rate) is preferably 30% or more from the viewpoint of the separation application of the alkali metal salt. An upper limit value thereof is not particularly limited, and is, for example, 50%.

### EXAMPLES

Hereinafter, the present invention will be described more specifically with reference to Examples. However, the present invention is not limited thereto.

### (1) Removal of Separation Functional Layer

The composite semipermeable membrane produced as described below was immersed in an aqueous solution containing 2 wt % of sodium hypochlorite at 20° C. for 24 hours to remove the separation functional layer.

### (2) Pressurization

A porous body obtained in (1) described above was cut to obtain a sample having a diameter of 7.6 cm. A surface of a porous layer of the sample was covered with a PTFE film having a thickness of 100 μm. A sintered plate, the porous body, and the PTFE film were stacked in this order in a pressurization device, and the aqueous solution was supplied to the PTFE film side under predetermined conditions, thereby performing pressurization under each of the conditions A, B, and C.

### (3) Surface Layer Elastic Moduli EA and EB

A porous support after the pressurization was fixed to a slide glass, and a cantilever of an atomic force microscope was pressed against the surface of the porous layer and then separated under the following conditions to obtain a force curve, and calculated the elastic modulus.
Observation device: scanning probe microscope (SPM) and Nano Scope V Dimension Icon manufactured by Bruker Corporation
Probe: Si cantilever (spring constant: about 2 N/m)
Scanning mode: force volume (contact mode)
Scanning range: 2 μm square
Number of counts: 64 per side
A deformation amount δ of the porous layer was calculated from the obtained force curve, and a load F applied to the porous layer was obtained by the following equation using a spring constant k of the cantilever.

$$Load F = k \times deflection amount d of cantilever \qquad Equation ( 1 )$$

$$Deformation amount δ = [ deformation amount Δ x of cantilever ] - [ deflection amount Δ y of cantilever ] \qquad Equation ( 2 )$$

Here, assuming that the cantilever is a rigid ball having a radius R and the porous layer is an elastic body plane with conversion elastic modulus K and cohesive energy ω per unit area, and a contact area between the probe and the porous layer is set as “a”, the following relationship is established using JKR contact theory.

$${α}^{3} = R / K [ F + 3 πω R + {\{ 6 π RF + {( 3 πω R )}^{2} \}}^{1 / 2} ] \qquad Equation ( 3 )$$

$$δ = {a}^{2} / 3 R + 2 F / 3 aK \qquad Equation ( 4 )$$

Further, the conversion elastic modulus K is expressed as follows using a Poisson's ratio v and an elastic modulus Young's modulus E of the porous layer.

$$K = 1.33 \times E / ( 1 - v 2 ) \qquad Equation ( 5 )$$

A value of the elastic modulus E was calculated from the above relational expressions (1) to (5) and values of a spring coefficient k and the radius R of the cantilever obtained in advance. In the present invention, the Poisson's ratio v=0.4 was used.

A series of operations was repeated while two-dimensionally scanning the cantilever in a range of 2 μm×2 μm to acquire a distribution of the elastic modulus of the surface, and an average value of all data (64×64) was taken as the surface layer elastic modulus EA or EB.

### (4) Dense Layer Measurement

The porous support after the pressurization was immersed in liquid nitrogen to be frozen as a pretreatment for maintaining a porous form, and then was cleaved and dried. Platinum/palladium or ruthenium tetroxide, preferably ruthenium tetroxide, was thinly deposited on the membrane cross section to obtain an observation sample. Thereafter, imaging magnification was set to 100,000 times, and an arbitrary cross section photo of the membrane cross section was obtained. With respect to a scope of the cross section photo, a membrane cross section photographic image was read in “image-J”, and the “type” was set to 8 bits in the “image”. Binarization processing was performed in “Threshold” by setting a minimum value of a threshold to 0 and a maximum value thereof to 115, and setting a portion within the range to be black and the rest to be white. A ratio of black to white was calculated every 20 nm from the surface, and a range in which an area of the black portion in the cross-sectional direction was less than 10% was defined as a dense layer thickness.
Device: electrolytic emission electron microscope JEM-F200 (manufactured by JEOL Ltd.)
Measurement condition: acceleration voltage 200 kV

### (5) Surface Roughness RaA, RaB, and RaC

The surface roughness RaA, RaB, and RaC of the porous support layer of the porous support after the pressurization was measured using the following atomic force microscope (AFM) device under the following conditions.
Device: atomic force microscope device (Dimension Fastscan manufactured by Brucker Co., Ltd.)
Condition: probe, SiN cantilever (ScanAsystAir manufactured by Brucker Co., Ltd.) Scanning mode: ScanAsyst in Air (in-gas measurement)
Rate: 3.91 Hz
Load: 5 nN
Scanning range: 20 μm square (in-gas measurement)
Scanning resolution: 512×512
Sample preparation: at the time of measurement, a membrane sample was immersed in ethanol at room temperature for 15 minutes, then immersed in RO water for 24 hours, washed, and then air-dried for use.

### (6) Area Ratio of Pores in Membrane Thickness Direction

The membrane cross section photographic image obtained by the method described in (4) above was subjected to the following processing and analysis by “image-J” which is image software. First, the image is converted into an 8-bit image by an “image” function. Next, binarization processing was performed in “Threshold” to set the minimum value of the threshold to 0, the maximum value thereof to 65, a portion within the range from the minimum value to the maximum value to be black, the rest to be white (a pore portion became black). Further, in “Filters”, Median and 1 pixel were selected to remove noise. A range of a width of 1800 nm×a depth of 1500 nm was selected with a position at a depth of 10 nm from the surface as an upper end, and a range other than the selected range was deleted by “Crop”. With respect to the image of the selected region, “Area” was selected in “Set Measurements”, “Fit ellipse” was further selected, and particle analysis was performed by “Analyze Particles”. In this case, a hollow portion of a particle was also included in an area of the particle by enabling an “include holes” function. Results of the elliptical approximation of Example 3 and Comparative Example 2 are shown in FIG. 4A and FIG. 4B.

Based on the result of the analysis thus obtained, a pore having an angle of 45 degrees or more and 135 degrees or less was defined as a pore in the thickness direction.

Area ratio of pores in membrane thickness direction=total area of pores in thickness direction/total area of all pores

(7) Water Permeability of Support The porous support was cut out into a circular shape having a diameter of 4.3 cm, and the cut out sample was set in a stirring type ultra holder (UHP-43K, manufactured by Advantec Toyo Kaisha, Ltd.) (effective filtration area: 10.9 cm²). Subsequently, pure water at 25° C. was put into the cell, a cap was attached, and a pressure was increased to 0.2 MPa with nitrogen. Finally, a permeate volume of the pure water for a certain period of time was measured, and the pure water permeability coefficient (×10⁻⁹ m³/(m²·s·Pa), 25° C.) was calculated from the following equation.

pure water permeability coefficient=permeate volume of pure water÷(membrane area×water collection time×supply pressure)

(8) Porosity in Portion from Surface of Porous Membrane to Depth of 500 nm

The membrane sample frozen by being immersed in the liquid nitrogen as the pretreatment for maintaining the porous form is cut off and dried, and then platinum/palladium, or ruthenium tetroxide, preferably ruthenium tetroxide, is thinly deposited on the membrane cross section to obtain an observation sample. Thereafter, the imaging magnification is set to 100,000 times, and an arbitrary cross section photo of the membrane cross section is obtained. With respect to the range of the cross section photo, the membrane cross section photographic image in the range of 500 nm from the surface is read in “image-J”, and the “type” is set to 8 bits in the “image”. The binarization processing was performed in “Threshold” to set the minimum value of threshold to 0, the maximum value thereof to 115, a portion within the range to be black, and the rest to be white, and an area ratio of the black portion was defined as the porosity.

### (9) Performance Evaluation of Composite Semipermeable Membrane as Reverse Osmosis Membrane

### (9-1) Desalination Rate (NaCl Removal Rate) and Boron Removal Rate

The raw water (NaCl concentration: 3.2 wt %, boron concentration: 5 ppm) adjusted to a temperature of 25° C. and a pH of 6.5 was supplied to the composite semipermeable membrane at the operation pressure of 5.5 MPa to perform a membrane filtration treatment for 2 hours, and thereafter, electrical conductivities of the supply water and the permeated water were measured by a multi water quality meter (MM60R) manufactured by DKK-TOA Corporation. Next, by using a calibration curve created in advance, the conductivity was converted to calculate the NaCl concentration. From this NaCl concentration, the salt removal performance, that is, the NaCl removal rate was obtained by the following equation.

$$NaCl removal rate ( \% ) = 100 \times \{ 1 - ( NaCl concentration in permeated water / NaCl concentration in supply water ) \}$$

Subsequently, the boron removal rate is calculated based on the following equation.

$$Boron removal rate ( \% ) = 100 \times \{ 1 - ( boron concentration in permeated water / boron concentration in supply water ) \}$$

The boron concentrations in the raw water and the permeated water were measured by using an ICP emission spectrometer (5110 ICP-OES, manufactured by Agilent Technologies) after collecting a sample liquid at the time of measuring the desalting performance.

### (9-2) Volume of Water Production (Flux)

In the tests described above, a volume of water permeating through the membrane for a certain period of time was measured, converted into the volume of permeated water (cubic meter) per square meter of the surface of the membrane and per day, and expressed as the volume of water production (m³/m²/day).

(9-3) Desalination Rate and Volume of Water Production after Pressurization

The raw water was supplied to the composite semipermeable membrane subjected to the performance evaluation in the above (9-1) at a temperature of 35° C. and an operation pressure of 7.0 MPa to be subjected to the membrane filtration treatment for 6 hours, and further the temperature returned to 25° C. and the operation pressure returned to 5.5 MPa, and the NaCl removal rate and the volume of water production after the pressurization were obtained in the same manner as in 7-1, and the desalination rate and the volume of water production after the high-pressure operation were obtained.

### Glucose Removal Rate and Isopropyl Alcohol Removal Rate

### (10-1) Isopropyl Alcohol Removal Rate

An evaluation was made by comparing isopropyl alcohol concentrations of the permeated water and the supply water when a 1000 ppm isopropyl alcohol aqueous solution adjusted to a temperature of 25° C. and a pH of 6.5 is supplied to the composite semipermeable membrane at an operation pressure of 0.75 MPa and a concentrated water flow rate of 3.5 L/min. That is, the isopropyl alcohol removal rate was calculated by isopropyl alcohol removal rate (%)=100×(1−(isopropyl alcohol concentration in permeated water/isopropyl alcohol concentration in supply water)). The isopropyl alcohol concentration was obtained by using a gas chromatograph (GC-18A manufactured by Shimadzu Corporation).

### (10-2) Glucose Removal Rate

An evaluation was made by comparing glucose concentrations of the permeated water and the supply water when a 1000 ppm glucose aqueous solution adjusted to a temperature of 25° C. and a pH of 6.5 is supplied to the composite semipermeable membrane at an operation pressure of 0.75 MPa and a concentrated water flow rate of 3.5 L/min. That is, the glucose removal rate was calculated by glucose removal rate (%)=100×(1−(glucose concentration in permeated water/glucose concentration in supply water)). The glucose concentration was obtained by a refractometer (RID-6A manufactured by Shimadzu Corporation).

(10-3) Desalination Rate (MgSO₄ Removal Rate) and Volume of Water Production (Flux) of Crosslinked Aliphatic Polyamide Separation Functional Layer-Based Composite Separation Membrane Salt water adjusted to a temperature of 25° C., a pH of 6.5, and an MgSO₄ concentration of 2000 mg/L was supplied to the composite semipermeable membrane at an operation pressure of 0.48 MPa to be subjected to the membrane filtration treatment. Thereafter, electrical conductivities of the supply water and the permeated water were measured with a multi water quality meter (MM60R) manufactured by DKK-TOA Corporation. Next, by using a calibration curve created in advance, the conductivity was converted to calculate the MgSO₄ concentration. From this MgSO₄ concentration, the salt removal performance, that is, the MgSO₄ concentration was obtained by the following equation.

$${MgSO}_{4} removal rate ( \% ) = 100 \times \{ 1 - ( {MgSO}_{4} concentration in permeated water / {MgSO}_{4} concentration in supply water ) \}$$

In the tests described above, a volume of water permeating through the membrane for a certain period of time was measured, converted into the volume of permeated water (cubic meter) per square meter of the surface of the membrane and per day, and expressed as the volume of water production (m³/m²/day).

(10-4) Desalination Rate (MgSO₄ Removal Rate) and Volume of Water Production after Pressurization

The salt water was supplied to the composite semipermeable membrane subjected to the performance evaluation in the above (10-3) at a temperature of 35° C. and an operation pressure of 7.0 MPa to be subjected to the membrane filtration treatment for 6 hours, and further the temperature returned to 25° C. and the operation pressure returned to 0.48 MPa, and the MgSO₄ removal rate and the volume of water production after the pressurization were obtained in the same manner as in (10-3) described above, and the desalination rate and the volume of water production after the high-pressure operation were obtained.

### (11) Preparation of Composite Semipermeable Membrane

A composite semipermeable membrane was produced as follows. Formation conditions of the porous support are shown in Table 1, characteristics of the porous support are shown in Tables 2 and 4, and characteristics of the composite semipermeable membrane are shown in Tables 3 and 5.

### Example 1

A DMF solution containing 15 wt % of polysulfone (PSf) was cast, under a condition of 25° C., on polyester nonwoven fabric (thickness: 90 μm, water permeability: 700 [10⁻⁹ m³/m²/s/Pa]) as a substrate, and within 1.0 second after being immersed in pure water, the pure water was pushed from the substrate side at a pressure of 1 kPa for about 3 seconds, and then the polyester nonwoven fabric was left in the pure water for 5 minutes to prepare a porous support. A thickness of the polysulfone layer was 40 μm.

The obtained porous support was immersed in an aqueous solution containing 3 wt % of m-phenylenediamine (m-PDA) for 2 minutes, the support was slowly pulled up in the vertical direction, nitrogen was blown from an air nozzle to remove an excess aqueous solution from the surface of the support membrane, and then a decane solution containing 0.165 wt % of trimesoyl chloride (TMC) was applied to completely wet the surface, the resultant was allowed to stand for 1 minute, and then the membrane was vertically held to allow the excess solution to flow down to remove the excess solution, and the membrane was washed with pure water to obtain a composite semipermeable membrane having a crosslinked aromatic polyamide separation functional layer.

### Example 2

A composite semipermeable membrane having a crosslinked aromatic polyamide separation functional layer was obtained in the same manner as in Example 1 except that the polysulfone concentration was 16 wt %.

### Example 3

A composite semipermeable membrane having a crosslinked aromatic polyamide separation functional layer was obtained in the same manner as in Example 1 except that the polysulfone concentration was 17 wt %.

### Example 4

A composite semipermeable membrane having a crosslinked aromatic polyamide separation functional layer was obtained in the same manner as in Example 1 except that the polysulfone concentration was 18 wt %.

### Example 5

A composite semipermeable membrane having a crosslinked aromatic polyamide separation functional layer was obtained in the same manner as in Example 4 except that the pure water was pushed from the substrate side at a pressure of 3 kPa for about 10 seconds.

### Example 6

A DMF solution containing 18 wt % of polysulfone (PSf) was cast, under the condition of 25° C., on polyester nonwoven fabric (thickness: 90 μm, water permeability: 700 [10⁻⁹ m³/m²/s/Pa]) and immersed in the pure water, and at the same time, the pure water was suctioned from the substrate side at a pressure of 1 kPa for about 10 seconds, and then the polyester nonwoven fabric was left in the pure water for 5 minutes to prepare a porous support. A thickness of the polysulfone layer was 40 μm.

A composite semipermeable membrane having a crosslinked aromatic polyamide separation functional layer was obtained in the same manner as in Example 1 except for the above.

### Example 7

A composite semipermeable membrane having a crosslinked aromatic polyamide separation functional layer was obtained in the same manner as in Example 1 except that the polysulfone concentration was 21 wt %.

### Example 8

First, a porous support was produced in the same manner as in Example 1. The obtained porous support was immersed for 30 seconds in an aqueous solution in which piperazine was dissolved at 1.0 wt % and sodium dodecyl diphenyl ether disulfonate was dissolved at 100 ppm, and then the support was slowly pulled up in the vertical direction, and nitrogen was blown from an air nozzle to remove the excess aqueous solution from the surface of the porous layer. Next, a decane solution containing 0.40 wt % of trimesoyl chloride (TMC) was applied to completely wet the surface of the porous layer, and left to stand for 30 seconds, and then the membrane was vertically held to allow the excess solution to flow down to remove the excess solution, and air was blown at 25° C. using a blower to dry the decane solution. Finally, the membrane was washed with the pure water at 80° C. to obtain a composite separation membrane having a crosslinked aliphatic polyamide separation functional layer.

### Example 9

A porous support was produced in the same manner as in Example 3. Thereafter, a composite semipermeable membrane having a crosslinked aliphatic polyamide separation functional layer was obtained in the same manner as in Example 8.

### Example 10

A composite semipermeable membrane having a crosslinked aromatic polyamide separation functional layer was obtained in the same manner as in Example 4 except that polyester nonwoven fabric (thickness: 90 μm, water permeability: 200 [10⁻⁹ m³/m²/s/Pa]) was used as the substrate.

### Example 11

A composite semipermeable membrane having a crosslinked aromatic polyamide separation functional layer was obtained in the same manner as in Example 5 except that polyester nonwoven fabric (thickness: 90 μm, water permeability: 200 [10⁻⁹ m³/m²/s/Pa]) was used as the substrate.

### Comparative Example 1

A DMF solution containing 16 wt % of polysulfone (PSf) was cast, under the condition of 25° C., on a polyester nonwoven fabric (thickness: 90 μm, water permeability: 700 [10⁻⁹ m³/m²/s/Pa]), immediately immersed in the pure water, and followed by standing for 5 minutes, thereby producing a porous support. A thickness of the polysulfone layer was 40 μm.

A composite semipermeable membrane having a crosslinked aromatic polyamide separation functional layer was obtained in the same manner as in Example 1 except for the above.

### Comparative Example 2

A composite semipermeable membrane having a crosslinked aromatic polyamide separation functional layer was obtained in the same manner as in Comparative Example 1 except that the polysulfone concentration was 17 wt %.

### Comparative Example 3

A DMF solution containing 18 wt % of polysulfone (PSf) was cast, under the condition of 25° C., on polyester nonwoven fabric (thickness: 90 μm, water permeability: 700 [10⁻⁹ m³/m²/s/Pa]), and after 5.0 seconds after being immersed in the pure water, the pure water was pushed from the substrate side at a pressure of 1 kPa for about 3 seconds, and then the polyester nonwoven fabric was left in the pure water for 5 minutes to prepare a porous support. A thickness of the polysulfone layer was 40 μm. A composite semipermeable membrane having a crosslinked aromatic polyamide separation functional layer was obtained in the same manner as in Example 1 except for the above.

### Comparative Example 4

A DMF solution containing 18 wt % of polysulfone (PSf) was cast, under the condition of 25° C., on polyester nonwoven fabric (thickness: 90 μm, water permeability: 700 [10⁻⁹ m³/m²/s/Pa]), and within 1.0 second after being immersed in the pure water, the pure water was pushed from the substrate side at a pressure of 1 kPa for about 3 seconds, and then the polyester nonwoven fabric was left in the pure water for 5 minutes to prepare a porous support.

Further, with respect to the produced porous support, a PTFE film having a thickness of 0.1 mm was laminated on a thermoplastic resin layer side of the porous support such that raw water permeate through the porous support and the composite semipermeable membrane in this order, and the raw water was supplied at an operation pressure of 5.5 MPa to perform the membrane filtration treatment for 2 hours, and then was supplied at a temperature of 35° C. and an operation pressure of 7.0 MPa to perform the membrane filtration treatment for 6 hours to obtain a porous support.

The obtained porous support was immersed in an aqueous solution containing 3 wt % of m-phenylenediamine (m-PDA) for 2 minutes, the support was slowly pulled up in the vertical direction, nitrogen was blown from an air nozzle to remove an excess aqueous solution from the surface of the support membrane, and then a decane solution containing 0.165 wt % of trimesoyl chloride (TMC) was applied to completely wet the surface, the resultant was allowed to stand for 1 minute, and then the membrane was vertically held to allow the excess solution to flow down to remove the excess solution, and the membrane was washed with pure water to obtain a composite semipermeable membrane having a crosslinked aromatic polyamide separation functional layer.

TABLE 1

| | Polysulfone | |
|---|---|---|
| | concentration | |
| | (wt %) | Push or suction water |
| Ex. 1 | 15 | Push, 1 kPa, 3 seconds |
| Ex. 2 | 16 | Push, 1 kPa, 3 seconds |
| Ex. 3 | 17 | Push, 1 kPa, 3 seconds |
| Ex. 4 | 18 | Push, 1 kPa, 3 seconds |
| Ex. 5 | 18 | Push, 3 kPa, 10 seconds |
| Ex. 6 | 18 | Suction, 1 kPa, 10 seconds |
| Ex. 7 | 21 | Push, 1 kPa, 3 seconds |
| Ex. 8 | Same as Ex. 1 | |
| Ex. 9 | Same as Ex. 3 | |
| Ex. 10 | 18 | Push, 1 kPa, 3 seconds |
| Ex. 11 | 18 | Push, 3 kPa, 10 seconds |
| Comp. Ex. 1 | 14 | Neither push nor suction |
| Comp. Ex. 2 | 17 | Neither push nor suction |
| Comp. Ex. 3 | 18 | Push, 1 kPa, 3 seconds |
| Comp. Ex. 4 | 18 | Push, 1 kPa, 3 seconds |

TABLE 2

| | | | | | Thickness | Pure water | Ratio (%) | Porosity [%] |
|---|---|---|---|---|---|---|---|---|
| | Surface | | | | (nm) of | permeability | of pores in | from surface |
| | elastic | Surface | Surface | | dense layer | coefficient | membrane | layer to |
| | modulus | roughness | roughness | | under | (10⁻⁹ m³/(m² · | thickness | depth of |
| | (EA) | RaA (nm) | RaC (nm) | RaA/RaC | condition A | sec · Pa)) | direction | 500 nm |
| Ex. 1 | 0.613 | 4.2 | 3.5 | 1.20 | 80 | 0.31 | 39 | 27 |
| Ex. 2 | 0.682 | 3.4 | 3.2 | 1.06 | 100 | 0.25 | 51 | 23 |
| Ex. 3 | 0.712 | 3.2 | 3 | 1.07 | 120 | 0.18 | 58 | 21 |
| Ex. 4 | 0.863 | 2.8 | 2.6 | 1.08 | 140 | 0.15 | 66 | 18 |
| Ex. 5 | 0.950 | 2.5 | 2.4 | 1.04 | 120 | 0.21 | 72 | 21 |
| Ex. 6 | 0.792 | 3.3 | 3.1 | 1.06 | 140 | 0.15 | 58 | 17 |
| Ex. 7 | 0.985 | 2.7 | 2.5 | 1.08 | 260 | 0.12 | 50 | 12 |
| Ex. 8 | 0.613 | 1.1 | 1.0 | 1.20 | 80 | 0.31 | 39 | 27 |
| Ex. 9 | 0.712 | 1.2 | 1.1 | 1.07 | 120 | 0.18 | 58 | 21 |
| Ex. 10 | 0.751 | 2.8 | 2.6 | 1.08 | 160 | 0.14 | 45 | 12 |
| Ex. 11 | 0.831 | 2.5 | 2.4 | 1.04 | 120 | 0.17 | 64 | 14 |
| Comp. Ex. 1 | 0.544 | 5.1 | 3.6 | 1.42 | 100 | 0.3 | 25 | 35 |
| Comp. Ex. 2 | 1.08 | 3.6 | 2.9 | 1.24 | 440 | 0.05 | 35 | 8 |
| Comp. Ex. 3 | 1.05 | 3.4 | 2.8 | 1.21 | 420 | 0.08 | 33 | 9 |
| Comp. Ex. 4 | 1.07 | 4.6 | 4.5 | 1.02 | 400 | 0.09 | 30 | 5 |

TABLE 3

| | | | | | | Volume of water |
|---|---|---|---|---|---|---|
| | | | | Volume of water | Desalination | production after |
| | Initial volume of | | Boron | production after | rate after | pressurization/ |
| | water production | Desalination | removal | pressurization | pressurization | initial volume of |
| | [m³/m²/d] | rate [%] | rate [%] | [m³/m²/d] | [%] | water production |
| Ex. 1 | 0.85 | 99.70 | 92 | 0.81 | 99.65 | 0.95 |
| Ex. 2 | 0.89 | 99.72 | 93 | 0.85 | 99.68 | 0.96 |
| Ex. 3 | 0.89 | 99.72 | 93 | 0.82 | 99.70 | 0.92 |
| Ex. 4 | 0.89 | 99.75 | 92 | 0.84 | 99.74 | 0.94 |
| Ex. 5 | 0.9 | 99.73 | 93 | 0.86 | 99.72 | 0.96 |
| Ex. 6 | 0.88 | 99.74 | 93 | 0.8 | 99.70 | 0.91 |
| Ex. 7 | 0.84 | 99.80 | 93 | 0.71 | 99.76 | 0.85 |
| Ex. 10 | 0.9 | 99.74 | 92 | 0.8 | 99.73 | 0.89 |
| Ex. 11 | 0.91 | 99.72 | 93 | 0.85 | 99.71 | 0.93 |
| Comp. Ex. 1 | 0.88 | 99.70 | 92 | 0.74 | 99.60 | 0.82 |
| Comp. Ex. 2 | 0.9 | 99.74 | 93 | 0.72 | 99.65 | 0.80 |
| Comp. Ex. 3 | 0.88 | 99.70 | 93 | 0.71 | 99.67 | 0.81 |
| Comp. Ex. 4 | 0.71 | 99.66 | 93 | 0.69 | 99.66 | 0.97 |

TABLE 4

| | | | | | Thickness | Pure water | Ratio (%) | Porosity [%] |
|---|---|---|---|---|---|---|---|---|
| | Surface | | | | (nm) of | permeability | of pores in | from surface |
| | elastic | Surface | Surface | | dense layer | coefficient | membrane | layer to |
| | modulus | roughness | roughness | | under | (10⁻⁹ m³/(m² · | thickness | depth of |
| | (EB) | RaC (nm) | RaB (nm) | RaB/RaC | condition B | sec · Pa)) | direction | 500 nm |
| Ex. 1 | 0.855 | 3.5 | 4.6 | 1.31 | 120 | 0.21 | 39 | 27 |
| Ex. 4 | 0.997 | 2.6 | 3 | 1.15 | 220 | 0.12 | 66 | 18 |
| Ex. 5 | 0.952 | 2.4 | 2.7 | 1.13 | 140 | 0.18 | 72 | 21 |
| Comp. Ex. 1 | 0.58 | 3.6 | 5.6 | 1.56 | 180 | 0.11 | 25 | 35 |
| Comp. Ex. 2 | 1.13 | 2.9 | 4 | 1.38 | 440 | 0.05 | 35 | 8 |
| Comp. Ex. 3 | 1.2 | 2.8 | 3.7 | 1.32 | 460 | 0.07 | 33 | 9 |
| Comp. Ex. 4 | 1.22 | 4.5 | 5.1 | 1.13 | 500 | 0.04 | 30 | 5 |

TABLE 5

| | Initial | | | | | | | Volume of water |
|---|---|---|---|---|---|---|---|---|
| | volume of | | | Isopropyl | Glucose removal | Volume of water | | production after |
| | water | MgSO4 | Glucose | alcohol | rate - isopropyl | production after | MgSO4 removal | pressurization/ |
| | production | removal | removal | removal | alcohol removal | pressurization | rate [%] after | initial volume of |
| | [m³/m²/d] | rate [%] | rate [%] | rate [%] | rate [%] | [m³/m²/d] | pressurization | water production |
| Ex. 8 | 0.85 | 95.70 | 92 | 60 | 32 | 0.81 | 95.75 | 0.95 |
| Ex. 9 | 0.9 | 96.20 | 93 | 55 | 38 | 0.82 | 96.31 | 0.91 |

Although the present invention has been described in detail with reference to specific embodiments, it is apparent to those skilled in the art that various changes and modifications can be made without departing from the spirit and scope of the present invention.

The present application is based on Japanese Patent Application No. 2022-009924 filed on Jan. 26, 2022, and the content thereof is incorporated herein by reference.

### INDUSTRIAL APPLICABILITY

A composite semipermeable membrane according to the present invention is used for seawater desalination, brackish water desalination, drinking water production, industrial ultrapure water production, drainage treatment, recovery of valuable materials, and the like.

### REFERENCE SIGNS LIST

1 composite semipermeable membrane
2 substrate
3 porous layer
31 dense layer
32 coarse layer
4 separation functional layer

1. A composite semipermeable membrane comprising a porous layer and a separation functional layer provided on the porous layer, wherein
at least one of a surface layer elastic modulus (EA) and a surface layer elastic modulus (EB) is 0.6 GPa or more and 1.0 GPa or less, provided that the surface layer elastic modulus (EA) is obtained by measuring a surface of the porous layer pressurized under a condition A (7 MPa, 35° C., 6 hours) with an atomic force microscope (AFM) and the surface layer elastic modulus (EB) is obtained by measuring the surface of the porous layer pressurized under a condition B (7 MPa, 45° C., 24 hours) with the atomic force microscope (AFM).

2. The composite semipermeable membrane according to claim 1, wherein
the porous layer pressurized under the condition A or the condition B includes a dense layer having a porosity of 10% or less, and
a thickness (d) of the dense layer is 300 nm or less.

3. The composite semipermeable membrane according to claim 1, wherein
at least one of a ratio (RaA/RaC) and a ratio (RaB/RaC) is 1.15 or less, provided that the ratio (RaA/RaC) is a ratio of a surface roughness (RaA) of the porous layer pressurized under the condition A to a surface roughness (RaC) of the porous layer pressurized under a condition C (5.5 MPa, 25° C., 2 hours) and the ratio (RaB/RaC) is a ratio of a surface roughness (RaB) of the porous layer pressurized under the condition B to the surface roughness (RaC) of the porous layer pressurized under the condition C.

4. The composite semipermeable membrane according to claim 1, further comprising a substrate, wherein
the porous layer is provided on the substrate to form a composite of the substrate and the porous layer, and
a pure water permeability coefficient of at least one of the composite pressurized under the condition A and the composite pressurized under the condition B is 0.12×10⁻⁹ m³/(m²·sec·Pa) or more.

5. The composite semipermeable membrane according to claim 1, wherein
an area ratio of a pore in a membrane thickness direction to an entire pore area in a range from the surface of the porous layer to a depth of 1.5 μm is 45% or more.

6. The composite semipermeable membrane according to claim 1, wherein
a boron removal rate (%) of 80% or more with respect to a raw water supplied at an operation pressure of 5.5 MPa and having a pH of 6.5, a temperature of 25° C., a boron concentration of 5 ppm, and a NaCl concentration of 3.2 wt % is exhibited.

7. The composite semipermeable membrane according to claim 1, wherein
a glucose removal rate is 90% or more and a value of (glucose removal rate—isopropyl alcohol removal rate) is 30% or more with respect to a 1000 ppm glucose aqueous solution having a temperature of 25° C. and a pH of 6.5 and a 1000 ppm isopropyl alcohol aqueous solution having a temperature of 25° C. and a pH of 6.5 which are supplied under conditions of an operation pressure of 0.75 MPa and a concentrated water flow rate of 3.5 L/min.

8. A method for producing a composite semipermeable membrane, the method comprising:
a step (a) of forming a resin solution in which a thermoplastic resin is dissolved in a good solvent into a flat membrane shape;
a step (b) of coagulating the thermoplastic resin in a coagulation liquid containing a non-solvent and a good solvent of the thermoplastic resin to obtain a porous layer; and
a step (c) of forming a separation functional layer on the porous layer, wherein
the step (b) includes forming a flow of the coagulation liquid in a thickness direction in the resin solution within 3 seconds after being immersed in the coagulation liquid.

9. The method for producing a composite semipermeable membrane according to claim 8, wherein
the resin solution is applied to a surface of a substrate, and
the coagulation liquid is pushed into the substrate from a back surface of the substrate to form the flow.
